(19) United States
(12) Patent Application Publication
(10) Pub. No.: US 2026/0284552 A1
(43) Pub. Date: Sep. 24, 2026

(54) Biological Material Purification Method, Magnetic Stand, And Biological Material Purification Device

(71) Applicant: SEIKO EPSON CORPORATION, Tokyo (JP)

(72) Inventors: Masato HANAMURA, Matsumoto (JP); Miki UCHIDA, Matsumoto (JP)

(21) Appl. No.: 19/570,763

(22) Filed: Mar. 18, 2026

(30) Foreign Application Priority Data
Mar. 19, 2025 (JP) 2025-046062

(51) Int. Cl. B01D 15/26; B01D 15/10; B01D 15/22; B01D 15/38; B01D 15/42

(52) U.S. Cl. CPC B01D 15/265; B01D 15/102; B01D 15/22; B01D 15/3885; B01D 15/424; B01D 2221/10

(57) ABSTRACT

A biological material purification method includes an adsorption step of charging magnetic beads having a saturation magnetization of 50 emu/g or more, a biological material, and a liquid into a container, adsorbing the biological material to the magnetic beads, and then removing the liquid, a washing step of washing the magnetic beads, and an elution step of eluting the biological material adsorbed to the magnetic beads. The washing step includes a magnetic bead collection treatment of immobilizing the magnetic beads by disposing a magnet such that an extension line of an orientation of a magnetic pole does not overlap the container, a wash solution discarding treatment of discarding a wash solution in the container, and a wash solution drying treatment of drying, after the wash solution discarding treatment, the wash solution in a state in which the magnet is disposed such that the extension line of the orientation of the magnetic pole overlaps the container and a magnetic field gradient in the container is 40 T/m or more.

The present application is based on, and claims priority from JP Application Serial Number 2025-046062, filed Mar. 19, 2025, the disclosure of which is hereby incorporated by reference herein in its entirety.

### BACKGROUND

### 1. Technical Field

The present disclosure relates to a biological material purification method, a magnetic stand, and a biological material purification device.

### 2. Related Art

A method using magnetic beads is known as a method for extracting biological materials such as nucleic acids.

For example, JP-A-2024-140111 discloses a biological material extraction method including a lysis and adsorption step, a washing step, and an elution step. In the lysis and adsorption step, nucleic acids are adsorbed to magnetic beads from a specimen sample containing the nucleic acids, and then a liquid is discarded using a magnetic separation technique. In the washing step, after the magnetic beads are washed with a wash solution, the wash solution is discarded using the magnetic separation technique. In the elution step, the nucleic acids captured by the magnetic beads are eluted using an elution solution, and then the elution solution is collected using the magnetic separation technique.

In addition, JP-A-2024-140111 also discloses that in the washing step, after the wash solution is discarded, a treatment of drying and removing the wash solution adhering to the magnetic beads is performed. When the wash solution is dried, a spike phenomenon is caused in the magnetic beads to increase a surface area. Accordingly, the drying efficiency can be increased.

JP-A-2024-140111 is an example of the related art.

However, when a particle diameter of the magnetic beads is small or the magnetic field is small, an increase in the surface area due to the spike phenomenon is insufficient, and the drying efficiency may not be sufficiently increased. Then, the wash solution remains on the magnetic beads, and the components of the wash solution are collected together with the nucleic acid in the elution step. The collected components of the wash solution are brought into a post-step such as a nucleic acid test, and cause a defect such as a test failure.

Therefore, an object is to efficiently remove the wash solution and to prevent occurrence of defects due to the wash solution being brought into a subsequent step.

### SUMMARY

A biological material purification method according to an application example of the present disclosure includes:
an adsorption step of charging magnetic beads having a saturation magnetization of 50 emu/g or more, a biological material, and a liquid into a container, adsorbing the biological material to the magnetic beads, and then removing the liquid;
a washing step of washing, with a wash solution, the magnetic beads to which the biological material is adsorbed after the adsorption step; and
an elution step of eluting the biological material adsorbed to the magnetic beads after the washing step. The washing step includes a magnetic bead collection treatment of immobilizing the magnetic beads by washing, with the wash solution, the magnetic beads to which the biological material is adsorbed, and then disposing a magnet such that an extension line of an orientation of a magnetic pole does not overlap the container, a wash solution discarding treatment of discarding the wash solution in the container in a state in which the magnetic beads are immobilized, and a wash solution drying treatment of drying, after the wash solution discarding treatment, the wash solution in a state in which the magnet is disposed such that the extension line of the orientation of the magnetic pole overlaps the container and a magnetic field gradient in the container is 40 T/m or more.

A magnetic stand according to an application example of the present disclosure is a magnetic stand for separating, by applying a magnetic field generated by a magnet to a container accommodating magnetic beads, a biological material, and a liquid, the magnetic beads and the liquid. The magnetic stand includes:
a base extending along a first axis and having an insertion hole into which the container is to be inserted; and
a magnetic field application unit provided on the base and configured to apply the magnetic field to the insertion hole. The magnetic field application unit includes a plurality of the magnets, and a movable portion configured to change positions of the magnets. The movable portion has a rod shape extending along a second axis intersecting the first axis, supports the plurality of magnets arranged along the second axis, and changes, by translating along the second axis or rotating around the second axis, an orientation of a magnetic field generated by the plurality of magnets.

A biological material purification device according to an application example of the present disclosure includes:
the magnetic stand according to the application example of the present disclosure;
a stand drive unit configured to drive the magnetic field application unit of the magnetic stand;
a wash solution supply unit configured to supply a wash solution to the container inserted into the insertion hole of the magnetic stand;
a wash solution discarding unit configured to discard the wash solution from the container; and
a control unit configured to control an operation of the stand drive unit, an operation of the wash solution supply unit, and an operation of the wash solution discarding unit.

### BRIEF DESCRIPTION OF THE DRAWINGS

FIG. 1 is a perspective view illustrating a magnetic stand according to an embodiment.

FIG. 2 is a plan view of the magnetic stand illustrated in FIG. 1.

FIG. 3 is a plan view of the magnetic stand illustrated in FIG. 1.

FIG. 4 is a cross-sectional view of the magnetic stand illustrated in FIG. 2 and a container set on the magnetic stand.

FIG. 5 is a cross-sectional view of the magnetic stand illustrated in FIG. 3 and a container set on the magnetic stand.

FIG. 6 is a flowchart illustrating a configuration of a biological material purification method according to the embodiment.

FIG. 7 is a schematic diagram illustrating the biological material purification method illustrated in FIG. 6.

FIG. 8 is a schematic diagram illustrating the biological material purification method illustrated in FIG. 6.

FIG. 9 is a schematic diagram illustrating the biological material purification method illustrated in FIG. 6.

FIG. 10 is a schematic diagram illustrating the biological material purification method illustrated in FIG. 6.

FIG. 11 is a cross-sectional view illustrating a magnetic bead.

FIG. 12 is a cross-sectional view illustrating an arrangement of magnets with respect to the container.

FIG. 13 is a plan view of a magnetic stand according to a modified example of the embodiment.

FIG. 14 is a cross-sectional view of the magnetic stand illustrated in FIG. 13 and the container set on the magnetic stand.

FIG. 15 is a cross-sectional view of the magnetic stand illustrated in FIG. 13 and the container set on the magnetic stand.

FIG. 16 is a schematic diagram illustrating a schematic configuration of a biological material purification device according to an embodiment.

FIG. 17 is Table 1 illustrating conditions of a washing step in nucleic acid purification using magnetic beads in Comparative Examples and evaluation results of the nucleic acid purification.

FIG. 18 is Table 2 illustrating conditions of washing steps in nucleic acid purification using magnetic beads of Examples and Comparative Examples and evaluation results of the nucleic acid purification.

FIG. 19 is Table 3 illustrating conditions of the washing step in nucleic acid purification using magnetic beads of Examples and Comparative Examples and evaluation results of the nucleic acid purification.

FIG. 20 is Table 4 illustrating conditions of the washing step in nucleic acid purification using magnetic beads of Examples and Comparative Examples and evaluation results of the nucleic acid purification.

### DESCRIPTION OF EMBODIMENTS

Hereinafter, preferred embodiments of a biological material purification method, a magnetic stand, and a biological material purification device according to the present disclosure will be described in detail with reference to the accompanying drawings.

### 1. Magnetic Stand

First, a magnetic stand according to an embodiment will be described.

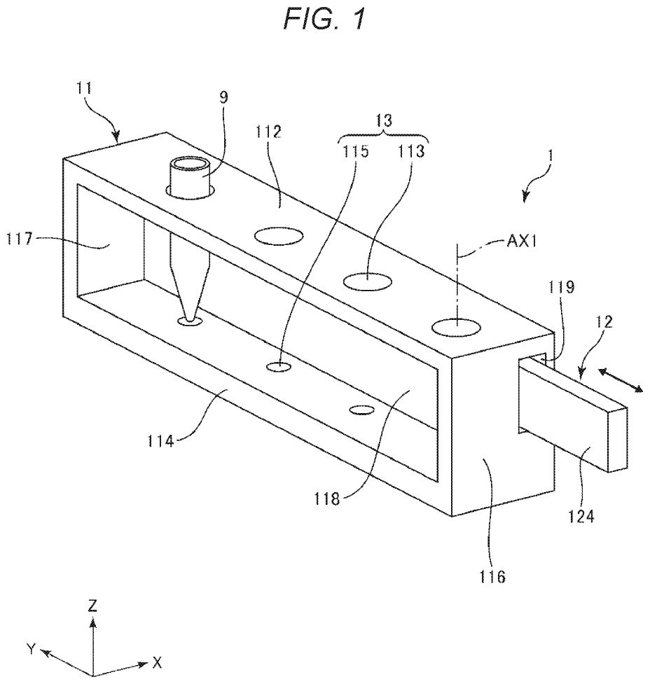

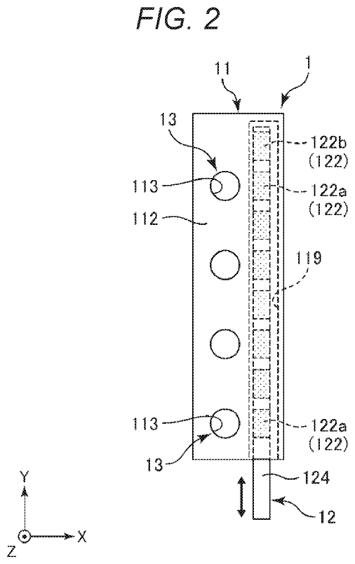

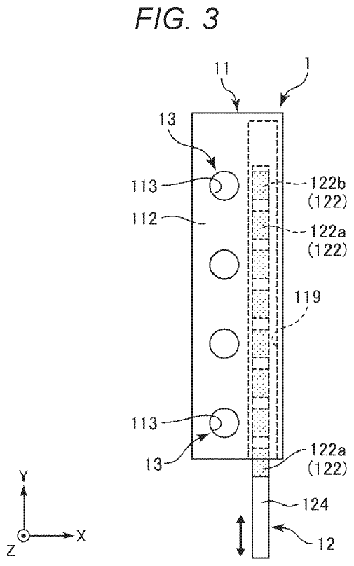

FIG. 1 is a perspective view illustrating a magnetic stand 1 according to the embodiment. FIGS. 2 and 3 are plan views of the magnetic stand 1 illustrated in FIG. 1.

Note in the drawings in the present application that an X axis, a Y axis, and a Z axis are set as three axes orthogonal to one another. Each axis is indicated by an arrow, a tip end side is defined as a “positive” side, and a base end side is defined as a “negative” side. In the following description, for example, the “X-axis direction” includes both a positive side of the X-axis and a negative side of the X-axis. The same applies to a Y-axis direction and a Z-axis direction. In the following description, a positive side of the Z-axis may be referred to as “upper” and a negative side of the Z-axis may be referred to as “lower”.

A magnetic stand 1 illustrated in FIG. 1 is a magnetic field generator that holds a container 9 such as a microtube and applies a magnetic field to a substance accommodated in the container 9.

The container 9 accommodates a mixed liquid containing magnetic beads, a biological material, and a dispersion medium. In the magnetic stand 1, the magnetic beads as a solid phase and the dispersion medium as a liquid phase are separated by applying a magnetic field to the mixed liquid accommodated in the container 9. Such a treatment is referred to as “magnetic separation”.

The magnetic stand 1 illustrated in FIG. 1 includes a base 11 and a magnetic field application unit 12.

The base 11 has insertion holes 13. The insertion hole 13 extends along the Z axis (first axis), and the container 9 is inserted into the insertion hole 13.

The magnetic field application unit 12 includes magnets 122 and a movable portion 124. The magnet 122 applies a magnetic field to the insertion hole 13. Accordingly, a magnetic field can be applied to the container 9 inserted into the insertion hole 13. The movable portion 124 has a rod shape extending along the Y axis (second axis) intersecting the Z axis, and supports the plurality of magnets 122 arranged along the Y axis. The movable portion 124 is translatable along the Y axis. When the movable portion 124 translates, the positions of the plurality of magnets 122 are changed, and an orientation of the magnetic field generated by the magnets 122 is changed.

In such a magnetic stand 1, the orientation of the magnetic field can be changed as described above, and therefore, an immobilized state of the magnetic beads accommodated in the container 9 can be changed. As will be described below, the immobilized state refers to a state in which the magnetic beads are small and gathered, a state in which the magnetic beads spread in a needle shape, or the like. By changing the immobilized state in this manner, the wash solution after washing the magnetic beads can be efficiently removed in the biological material purification method described below. Accordingly, the occurrence of defects due to the wash solution being brought into the subsequent step can be prevented.

### 1.1. Base

The base 11 illustrated in FIG. 1 includes an upper plate 112, a lower plate 114, side plates 116 and 117 coupling the upper plate 112 and the lower plate 114 to each other, and a back plate 118. The upper plate 112 and the lower plate 114 each have a plate shape extending in an X-Y plane. The side plates 116 and 117 each have a plate shape extending in an X-Z plane. Further, the back plate 118 has a plate shape extending in a Y-Z plane.

The upper plate 112 has a plurality of through holes 113. The through hole 113 penetrates the upper plate 112 along the Z axis. A plurality of through holes 113 are arranged at predetermined intervals along the Y axis.

The lower plate 114 is disposed below and apart from the upper plate 112. The lower plate 114 has a plurality of recessed portions 115. The recessed portion 115 is opened upward. The plurality of recessed portions 115 are arranged at predetermined intervals along the Y axis. In the X-Y plane, a position of the through hole 113 and a position of the recessed portion 115 corresponding to each other coincide with each other. Accordingly, a pair of the through hole 113 and the recessed portion 115 constitute the insertion hole 13 extending along an axis AX1. When the container 9 is inserted from above the through hole 113, the container 9 is held by the through hole 113 and the recessed portion 115. That is, the container 9 is held in the insertion hole 13 while standing.

The base 11 may have only one insertion hole 13, and preferably has a plurality of insertion holes 13. The insertion holes 13 are arranged at predetermined intervals along the Y axis. As an example, the base 11 illustrated in FIGS. 1 to 3 has four insertion holes 13.

An inner wall surface of the through hole 113 illustrated in FIG. 1 has a continuous annular shape such that the axis AX1 is surrounded, but is not limited thereto. The inner wall surface may have a partially discontinuous shape. Similarly, an inner wall surface of the recessed portion 115 illustrated in FIG. 1 also has a continuous annular shape, but is not limited thereto. The inner wall surface may have a partially discontinuous shape. The recessed portion 115 may penetrate the lower plate 114. Further, when a posture of the container 9 can be maintained only by the through hole 113, the recessed portion 115 may be omitted.

The side plate 116 couples an end portion of the upper plate 112 on a negative side of the Y axis and an end portion of the lower plate 114 on the negative side of the Y axis. The side plate 117 couples an end portion of the upper plate 112 on a positive side of the Y axis and an end portion of the lower plate 114 on the positive side of the Y axis. The upper plate 112, the lower plate 114, the side plate 116, and the side plate 117 constitute a frame.

The back plate 118 closes an opening on a positive side of the X axis of the frame. A magnetic field application unit insertion hole 119 is formed in the back plate 118. The magnetic field application unit insertion hole 119 is opened in a surface of the side plate 116 on the negative side of the Y axis and extends in the back plate 118 toward the positive side of the Y axis. The magnetic field application unit 12 described below is inserted into the magnetic field application unit insertion hole 119. When the magnetic field application unit 12 is inserted into the magnetic field application unit insertion hole 119, the magnet 122 of the magnetic field application unit 12 can be disposed in a vicinity of the container 9 set in the magnetic stand 1. Further, the orientation of the magnetic field generated by the magnet 122 can be changed by translating the movable portion 124 with respect to the magnetic field application unit insertion hole 119.

A constituent material of the base 11 is not particularly limited, and for example, a resin material such as acrylonitrile butadiene styrene (ABS), polypropylene, or nylon, a metal material such as an aluminum alloy, or the like is used.

A shape of the base 11 is not limited to the illustrated shape, and may be any shape as long as it has the insertion hole 13.

### 1.2. Magnetic Field Application Unit

The magnetic field application unit 12 is located on the positive side of the X axis of the insertion hole 13 and is provided between the upper plate 112 and the lower plate 114. As illustrated in FIGS. 2 and 3, the magnetic field application unit 12 includes the magnets 122 and the movable portion 124.

The magnet 122 may be an electromagnet, and is preferably a permanent magnet. Accordingly, a power supply of the magnetic stand 1 is not required, and a size and a weight thereof can be easily reduced. The portability of the magnetic stand 1 is improved, and therefore, a degree of freedom in a placement location is increased.

Examples of the permanent magnet include a neodymium iron boron magnet, a samarium-cobalt magnet, a ferrite magnet, and an alnico magnet.

A magnetic flux density on a surface (surface magnetic flux density) of the magnet 122 is preferably 50 mT or more, and more preferably 200 mT or more. Accordingly, it is possible to increase a movement speed of the magnetic beads in the magnetic separation, and the immobilized magnetic beads can be prevented from falling off. The surface magnetic flux density of the magnet 122 is measured by, for example, a Gauss meter using a Hall element.

The size of the magnet 122 is appropriately selected according to the size of the container 9 and the like.

The number of magnets 122 of the magnetic field application unit 12 is preferably twice or more the number of insertion holes 13. For example, as illustrated in FIGS. 1 to 3, when there are four insertion holes 13, the number of magnets 122 is preferably 8 or more. Accordingly, two magnets 122 having different magnetic pole orientations can correspond to one insertion hole 13. As a result, the orientation of the magnetic field with respect to the container 9 can be changed by changing a relative position of the magnet 122 with respect to the insertion hole 13 using the movable portion 124.

An arrangement cycle of the magnets 122 is preferably half an arrangement cycle of the insertion holes 13. Accordingly, two magnets 122 can accurately correspond to one insertion hole 13.

Here, an operation of the magnetic field application unit 12 will be described.

FIGS. 2 and 3 illustrate a state in which a relative position of the magnetic field application unit 12 with respect to the base 11 is changed. That is, the magnetic field application unit 12 can be disposed at a position illustrated in FIG. 3 by moving the magnetic field application unit 12 at a position illustrated in FIG. 2 to the negative side of the Y axis.

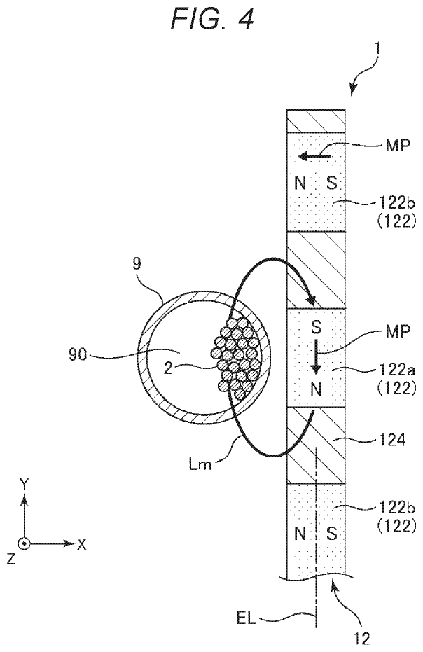

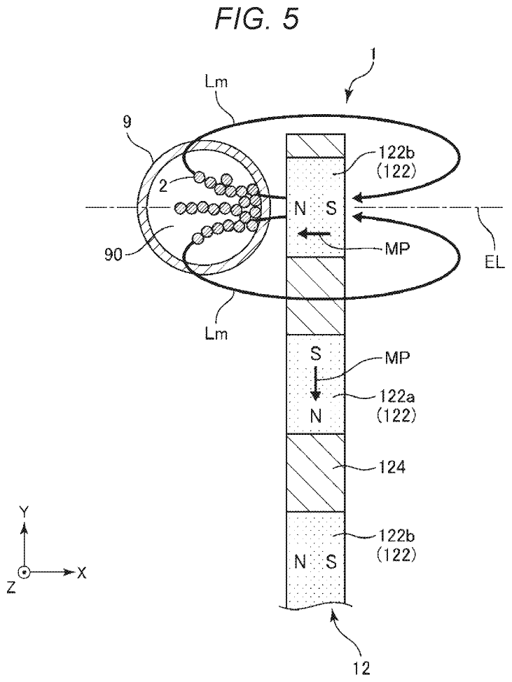

FIG. 4 is a cross-sectional view of the magnetic stand 1 illustrated in FIG. 2 and the container 9 set on the magnetic stand 1. FIG. 5 is a cross-sectional view of the magnetic stand 1 illustrated in FIG. 3 and the container 9 set on the magnetic stand 1.

FIGS. 4 and 5 illustrate the container 9 inserted into one of the insertion holes 13 illustrated in FIGS. 2 and 3, and a part of the magnetic field application unit 12 adjacent thereto.

Among the plurality of magnets 122 of the magnetic field application unit 12, a magnet whose extension line in an orientation of a magnetic pole MP does not overlap the container 9 is referred to as a “first magnet 122a”, and a magnet whose extension line in an orientation of the magnetic pole MP overlaps the container 9 is referred to as a “second magnet 122b”.

Whether the extension line of the orientation of the magnetic pole MP overlaps the container 9 is determined when the target container 9 and the magnet 122 are closest to each other. Therefore, as illustrated in FIGS. 4 and 5, the magnet 122 whose magnetic pole MP faces the negative side of the Y axis is the first magnet 122a, and the magnet 122 whose magnetic pole MP faces the negative side of the X axis is the second magnet 122b. In the present specification, the “orientation of the magnetic pole MP” refers to an orientation from an S pole to an N pole inside the magnet 122 when the magnet 122 is viewed from the Z-axis direction. The “extension line of the orientation of the magnetic pole MP” is a straight line that passes through the middle of the width of the magnet 122 (the width in the direction perpendicular to the orientation of the magnetic pole MP) and is parallel to the magnetic pole MP when the magnet 122 is viewed from the Z-axis direction. In FIGS. 4 and 5, an extension line EL is illustrated.

As illustrated in FIGS. 4 and 5, in the magnetic field application unit 12, the first magnets 122a and the second magnets 122b are disposed such that they are alternately adjacent to each other in the Y-axis direction.

When the relative position of the magnetic field application unit 12 is a position illustrated in FIG. 4, the magnetic field generated by the first magnet 122a is applied to the container 9. Then, as illustrated in FIG. 4, the magnetic flux lines Lm from the N pole to the S pole of the first magnet 122a include a large number of components parallel to the Y-axis direction. The magnetic field represented by the magnetic flux lines Lm acts on the magnetic beads 2 accommodated in the container 9.

On the other hand, when the relative position of the magnetic field application unit 12 is a position illustrated in FIG. 5, a magnetic field generated by the second magnet 122b is applied to the container 9. Then, the magnetic flux lines Lm from the N pole to the S pole of the second magnet 122b include a large number of components parallel to the X axis as illustrated in FIG. 5. The magnetic field represented by the magnetic flux lines Lm acts on the magnetic beads 2 accommodated in the container 9.

As described above, the movable portion 124 has a rod shape extending along the Y axis (second axis) and supports the plurality of magnets 122 arranged along the Y axis.

The movable portion 124 is translatable along the Y axis. When the movable portion 124 is translated along the Y-axis, the positions of the plurality of magnets 122 can be changed, and the orientation of the magnetic field generated by the magnet 122 can be changed.

A constituent material of the movable portion 124 is not particularly limited, and examples thereof include a resin material, a ceramic material, and a non-magnetic metallic material. Among them, a resin material is preferably used from the viewpoint of moldability, impact resistance, and the like.

As illustrated in FIGS. 2 and 3, when the magnetic field application unit 12 is inserted into the magnetic field application unit insertion hole 119 of the base 11, a part of the movable portion 124 protrudes from the magnetic field application unit insertion hole 119. The protruded portion serves as a grip portion to be gripped by an operator, and enables a relative movement of the magnetic field application unit 12. The movable portion 124 may be coupled to a drive unit (not illustrated) and may be moved by power generated from the drive unit.

According to the above configuration, it is possible to implement the magnetic stand 1 capable of easily changing the orientation of the magnetic field applied to the container 9 by translating the magnetic field application unit 12 in the Y-axis direction. In addition, changing the orientation of the magnetic field leads to changing the distance between the N pole and the S pole with respect to the container 9. Therefore, it is possible to implement the magnetic stand 1 capable of easily changing the magnetic flux density formed in the container 9 and easily changing the immobilized state of the magnetic beads 2. Such a magnetic stand 1 is particularly effectively used in the biological material purification method described below.

The above magnetic bead 2 is a particle group that adsorbs a biological material and is used for magnetic separation. Magnetic separation is a technique of applying a magnetic field to a container in which a solid phase containing the magnetic beads 2 and a liquid phase containing a solvent or the like are charged to magnetically attract the solid phase and thus separating the solid phase from the liquid phase.

Examples of the biological material include nucleic acids such as DNA, RNA, and hybrids thereof. The biological material may be a biological component other than the nucleic acid. The nucleic acid or the biological component may be present in a state of being contained in, for example, a biological sample such as a cell or a biological tissue, a virus, or a bacterium. The biological material purification method described below is a method of purifying such a biological material through steps of, for example, adsorption, separation, washing, and elution. In the following description, a case where the biological material is a nucleic acid will be described as an example, and the following description can be similarly applied to a case where the biological material is a biological component other than a nucleic acid.

### 2. Biological Material Purification Method

Next, a biological material purification method according to an embodiment will be described.

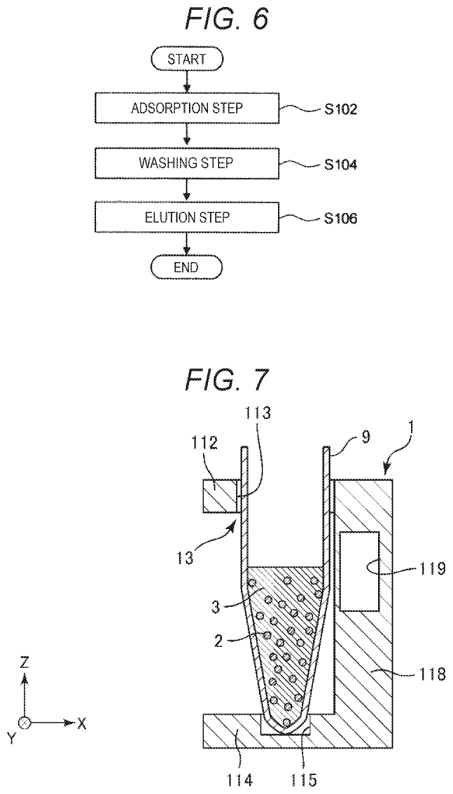

FIG. 6 is a flowchart illustrating a configuration of the biological material purification method according to the embodiment. FIGS. 7 to 10 are schematic diagrams illustrating the biological material purification method illustrated in FIG. 6.

### 2.1. Overview

The biological material purification method illustrated in FIG. 6 is a method for purifying a biological material, and includes an adsorption step S102, a washing step S104, and an elution step S106.

In the adsorption step S102, a mixed liquid obtained by mixing the magnetic beads 2 having a saturation magnetization of 50 emu/g or more, a nucleic acid (biological material) (not illustrated), and a lysis-adsorption liquid (liquid 3) is prepared in the container 9 illustrated in FIG. 7. Then, the nucleic acid is adsorbed to the magnetic bead 2 in the mixed liquid. Subsequently, the magnetic beads 2 to which the nucleic acids are adsorbed are magnetically separated from the mixed liquid in the container 9.

In the washing step S104, the magnetic beads 2 to which the nucleic acids are adsorbed are washed with a wash solution in the container 9.

In the elution step S106, the nucleic acids are eluted from the magnetic beads 2 to which the nucleic acids are adsorbed in the container 9.

In the present embodiment, the washing step S104 includes a magnetic bead collection treatment, a wash solution discarding treatment, and a wash solution drying treatment.

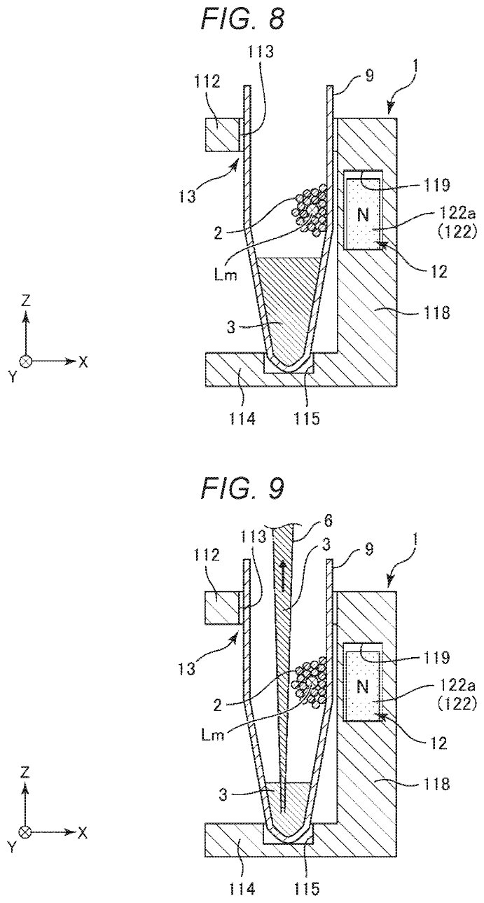

In the magnetic bead collection treatment, after the magnetic beads 2 to which the nucleic acids are adsorbed are washed with a wash solution, as illustrated in FIG. 4, the magnets 122 are disposed such that the extension line EL of the orientation of the magnetic pole MP does not overlap the container 9. Accordingly, as illustrated in FIG. 8, the magnetic beads 2 can be immobilized to an inner wall of the container 9.

In the wash solution discarding treatment, as illustrated in FIG. 9, the wash solution in the container 9 is discarded by a pipette 6 in a state in which the magnetic beads 2 are fixed.

In the wash solution drying treatment, after the wash solution discarding treatment, as illustrated in FIG. 5, the magnets 122 are disposed such that the extension line of the orientation of the magnetic pole MP of the magnet 122 overlaps the container 9, and a magnetic field gradient in the container 9 is 40 T/m or more. That is, in the wash solution drying treatment, the magnetic stand 1 is operated to change the immobilized state of the magnetic beads 2 from that in the wash solution discarding treatment. Then, the wash solution is dried in the changed immobilized state.

According to such a configuration, the immobilized state of the magnetic beads 2 can be optimized in the wash solution drying treatment, and therefore, the wash solution can be sufficiently dried. Accordingly, the occurrence of defects due to the wash solution being brought into the subsequent step can be prevented. Examples of the subsequent step include a test using PCR of nucleic acid.

According to the configuration described above, the immobilized state of the magnetic beads 2 can be optimized in the wash solution discarding treatment, and therefore, the interference between the immobilized magnetic beads 2 and the pipette 6 can be prevented. Accordingly, the workability of the wash solution discarding treatment can be improved, and the wash solution can be efficiently removed.

Hereinafter, the steps will sequentially be described.

### 2.2. Adsorption Step

In the adsorption step S102, the lysis-adsorption liquid (liquid 3 illustrated in FIG. 7) to which a specimen sample containing a nucleic acid is added and the magnetic beads 2 are charged into the container 9 illustrated in FIG. 7. Then, substances accommodated in the container 9 are mixed. Accordingly, as illustrated in FIG. 7, the magnetic beads 2 are dispersed in the lysis-adsorption liquid in the container 9. The nucleic acid is usually enclosed in a cell membrane or a nucleus. The nucleic acid is extracted from the specimen sample when a so-called outer shell of the cell membrane or the nucleus is lysed and removed by a lysis action of the lysis-adsorption liquid. Thereafter, the nucleic acid is captured by the magnetic bead 2 by an adsorption action of the lysis-adsorption liquid.

As the lysis-adsorption liquid, for example, a liquid containing Proteinase K, a chaotropic substance, and the like is used. Proteinase K degrades proteins and solubilizes nucleic acids. The chaotropic substance generates chaotropic ions in an aqueous solution to reduce an interaction between water molecules, thereby destabilizing a structure. This contributes to the adsorption of nucleic acids.

As the lysis-adsorption liquid, for example, water such as sterile water is used. Any additive may be added to the lysis-adsorption liquid. Examples of the additive include a salt, a buffer, a surfactant, an organic solvent, an acid, and a base.

Examples of the salt include sodium chloride, lithium chloride, potassium carbonate, and trisodium citrate.

Examples of the buffer include an acetate buffer, a phosphate buffer, a formic acid buffer, a citrate buffer, and a tartrate buffer.

Examples of the surfactant include a triton surfactant such as Triton X-100, a nonionic surfactant such as a Tween surfactant such as Tween20, and an anionic surfactant such as sodium N-lauroylsarcosine (SDS).

Examples of the organic solvent include alcohols such as ethanol.

In the adsorption step S102, the substances accommodated in the container 9 may be mixed. Accordingly, as illustrated in FIG. 7, the magnetic beads 2 are dispersed in the lysis-adsorption liquid (liquid 3), and therefore, the probability that the nucleic acid is captured by the magnetic beads 2 can be increased. In the mixing, for example, a vortex mixer, hand shaking, or pipetting is used.

FIG. 11 is a cross-sectional view illustrating the magnetic bead 2. The magnetic bead 2 illustrated in FIG. 11 includes a magnetic metal particle 22 and a coating layer 24. A metal powder having magnetism is used as the magnetic metal particle 22. The coating layer 24 contains an inorganic oxide. The magnetic beads 2 will be described in detail later.

Subsequently, a magnetic field is applied to the mixed liquid containing the magnetic beads 2 to which the nucleic acids are adsorbed, and the mixed liquid is magnetically attracted to the inner wall of the container 9. Accordingly, as illustrated in FIG. 8, the magnetic beads 2 are moved to an inner wall of the container 9 and immobilized. As a result, the magnetic beads 2 as a solid phase and the lysis-adsorption liquid (liquid 3) as a liquid phase can be separated.

Next, the lysis-adsorption liquid in the container 9 is discarded in a state in which the magnetic beads 2 are immobilized. Specifically, as illustrated in FIG. 9, the lysis-adsorption liquid (liquid 3) accumulated at a bottom of the container 9 is sucked and discarded by the pipette 6. Accordingly, the magnetic beads 2 capturing the nucleic acid remain in the container 9.

After the lysis-adsorption liquid is discarded, acceleration may be applied to the container 9 as necessary. Accordingly, the lysis-adsorption liquid adhering to the magnetic beads 2 can be shaken off, and thus the unseparated lysis-adsorption liquid can be reduced. The acceleration may be a centrifugal acceleration. A centrifugal separator may be used to apply the centrifugal acceleration.

### 2.3. Washing Step

In the washing step S104, the magnetic beads 2 to which the nucleic acids are adsorbed are washed. washing refers to a treatment of transferring foreign substances captured by the magnetic beads 2 to the wash solution and removing the foreign substances by bringing the magnetic beads 2, to which the nucleic acid is adsorbed, into contact with a wash solution in the container 9 and then separating the magnetic beads 2 from the wash solution again in order to remove the impurities. In this case, the liquid 3 in FIGS. 7 to 9 is a wash solution.

In the washing step S104, first, the substances accommodated in the container 9 are mixed. Accordingly, as illustrated in FIG. 7, the magnetic beads 2 are dispersed in the wash solution (liquid 3), and therefore, the washing efficiency of the magnetic beads 2 can be increased. In the mixing, for example, a vortex mixer, hand shaking, or pipetting is used. This mixing is preferably performed in a state in which no magnetic field is applied.

Next, the magnetic bead collection treatment, the wash solution discarding treatment, and a wash solution drying treatment are sequentially performed.

### 2.3.1. Magnetic Bead Collection Treatment

In the magnetic bead collection treatment, the magnetic beads 2 to which nucleic acids are adsorbed are washed with a wash solution, and then the container 9 is set on the magnetic stand 1. Then, as illustrated in FIG. 4, the magnets 122 are disposed such that the extension line EL of the orientation of the magnetic pole MP does not overlap the container 9. That is, the first magnet 122a illustrated in FIG. 8 is disposed close to the container 9. Accordingly, as illustrated in FIG. 8, the magnetic beads 2 can be immobilized to an inner wall of the container 9. The extension line EL not overlapping the container 9 means that the extension line EL does not pass through an internal space 90 of the container 9 as illustrated in FIG. 4.

### 2.3.2. Wash Solution Discarding Treatment

In the wash solution discarding treatment, the wash solution (liquid 3) accumulated at the bottom of the container 9 is discarded by the pipette 6 as illustrated in FIG. 9 in a state in which the magnetic beads 2 are immobilized. Accordingly, the washed magnetic beads 2 remain in the container 9.

In the magnetic bead collection treatment described above, as illustrated in FIG. 4, the magnets 122 are disposed such that the extension line EL does not overlap the container 9, and therefore, the magnetic flux lines Lm generated from the magnets 122 include a large number of components in the Y-axis direction as illustrated in FIG. 4. In such magnetic flux lines Lm, a magnetic flux density of a component from the inner wall of the container 9 toward a center of the container 9 is low. Therefore, the magnetic beads 2 are immobilized to the inner wall of the container 9 in a compact state as illustrated in FIG. 9. That is, the occurrence of a phenomenon (spike phenomenon) in which the magnetic beads 2 are arranged in a needle shape can be prevented. Accordingly, a sufficient space for inserting and removing the pipette 6 can be ensured in the internal space 90 of the container 9. As a result, the discarding work of the wash solution by the pipette 6 can be efficiently performed.

### 2.3.3. Wash Solution Drying Treatment

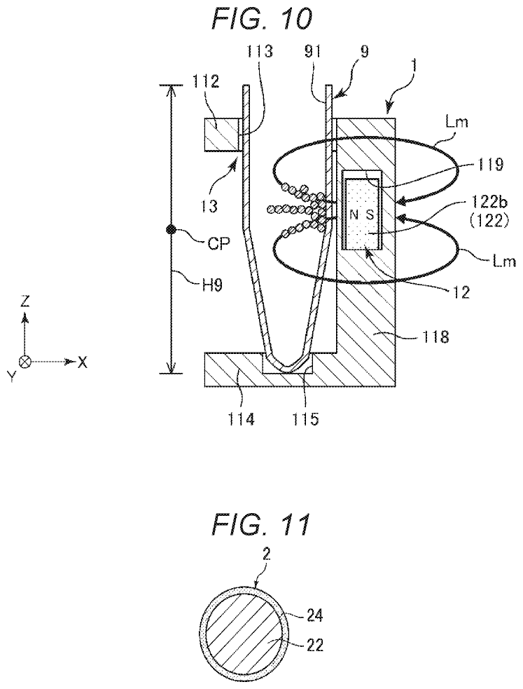

In the wash solution drying treatment, the magnetic field application unit 12 of the magnetic stand 1 is operated to change the relative position of the magnetic field application unit 12 with respect to the base 11 from the position illustrated in FIG. 2 to the position illustrated in FIG. 3. That is, as illustrated in FIG. 5, the magnets 122 are disposed such that the extension line EL of the orientation of the magnetic pole MP of the magnet 122 overlaps the container 9. The extension line EL overlapping the container 9 means that the extension line EL passes through the internal space 90 of the container 9 as illustrated in FIG. 5. Accordingly, as illustrated in FIG. 5, the magnetic flux lines Lm generated from the magnet 122 include a large number of components in the X-axis direction. Such magnetic flux lines Lm have a high magnetic flux density of a component from the inner wall of the container 9 toward the center of the container 9. Therefore, a phenomenon (spike phenomenon) in which the magnetic beads 2 are arranged in a needle shape as illustrated in FIG. 10 occurs in the magnetic beads 2. When the spike phenomenon occurs, the total surface area of the fixed magnetic beads 2 can be increased. Accordingly, the wash solution d adhering to the magnetic beads 2 can be efficiently dried. As a result, the wash solution can be efficiently removed, and the components in the wash solution can be prevented from being brought into the subsequent step.

In the magnetic stand 1 illustrated in FIG. 1, the state in which the first magnet 122a is disposed close to the container 9 and the state in which the second magnet 122b is disposed close to the container 9 can be easily switched only by translating the movable portion 124 along the Y axis (second axis).

In the wash solution drying treatment, the magnetic beads 2 having a saturation magnetization of 50 emu/g or more are used, and the magnets 122 are disposed such that the magnetic field gradient in the container 9 is 40 T/m or more. In this state, the wash solution is dried.

According to such a configuration, the wash solution can be sufficiently dried, and the drying efficiency can be increased. As a result, the components in the wash solution brought into the subsequent step can be minimized.

When the saturation magnetization is less than the above lower limit, the magnetic attraction force generated in the magnetic bead 2 decreases, and the occurrence of the spike phenomenon is insufficient. Then, the drying efficiency decreases, and the wash solution may remain.

The saturation magnetization of the magnetic beads 2 is preferably 100 emu/g or more, and more preferably 150 emu/g or more. The saturation magnetization is a magnetization value in a case where a magnetization exhibited by a magnetic material when a sufficiently large magnetic field is externally applied is constant regardless of the magnetic field. When the saturation magnetization is within the above range, the drying efficiency of the magnetic beads 2 can be particularly increased. A movement speed of the magnetic bead 2 in a magnetic field can be increased, and therefore, a time required for magnetic separation can be shortened. The saturation magnetization of the magnetic bead 2 affects an adsorption force when the magnetic bead 2 is fixed by a magnetic field. When the saturation magnetization is within the above range, a sufficiently high adsorption force can be obtained, and therefore, when the liquid 3 is discarded in a state in which the magnetic bead 2 is immobilized, the magnetic bead 2 can be prevented from being discarded together with the liquid 3. Accordingly, a decrease in a nucleic acid yield due to a decrease in the number of magnetic beads 2 can be prevented.

An upper limit of the saturation magnetization is not particularly limited, and the saturation magnetization is preferably 300 emu/g or less from the viewpoint of ease of selection of a material suitable for a balance between performance and cost.

The saturation magnetization of the magnetic bead 2 can be measured by a vibrating sample magnetometer (VSM) or the like. As the vibrating sample magnetometer, for example, TM-VSM1230-MHHL manufactured by Tamakawa Co., Ltd. may be used. A maximum applied magnetic field when measuring the saturation magnetization is, for example, 0.5 T or more.

On the other hand, when the magnetic field gradient is less than the lower limit, the magnetic attraction force generated in the magnetic bead 2 decreases, and the occurrence of the spike phenomenon is insufficient. Then, the drying efficiency decreases, and the wash solution may remain.

The magnetic field gradient is preferably 100 T/m or more, and more preferably 150 T/m or more. When the magnetic field gradient is within the above range, the drying efficiency of the magnetic beads 2 can be particularly increased. A movement speed of the magnetic bead 2 in a magnetic field can be increased, and therefore, a time required for magnetic separation can be shortened. The magnetic field gradient in the container 9 affects the adsorption force when the magnetic beads 2 are immobilized by the magnetic field. When the magnetic field gradient is within the above range, a sufficiently high adsorption force can be obtained, and therefore, when the liquid 3 is discarded in a state in which the magnetic bead 2 is immobilized, the magnetic bead 2 can be prevented from being discarded together with the liquid 3. Accordingly, a decrease in a nucleic acid yield due to a decrease in the number of magnetic beads 2 can be prevented.

The upper limit of the magnetic field gradient is not particularly limited, and is preferably 400 T/m or less from the viewpoint of ease of selection of the magnet 122, restriction on the distance between the container 9 and the magnet 122, and the like.

A point closest to the container 9 on a surface of the magnet 122 is defined as a measurement point a, and a point closest to the magnet 122 in the internal space 90 of the container 9 is defined as a measurement point b. The magnetic field gradient G in this case can be considered as a difference between a magnetic field at the measurement point a and a magnetic field at the measurement point b. Therefore, the distance [m] between the measurement point a and the measurement point b is represented by Δs. The magnetic field [T] at the measurement point a is represented by Ba, and the magnetic field [T] at the measurement point b is represented by Bb. Then, the magnetic field gradient G is determined by the following formula (1).

G=(Ba-Bb)/Δs (1)

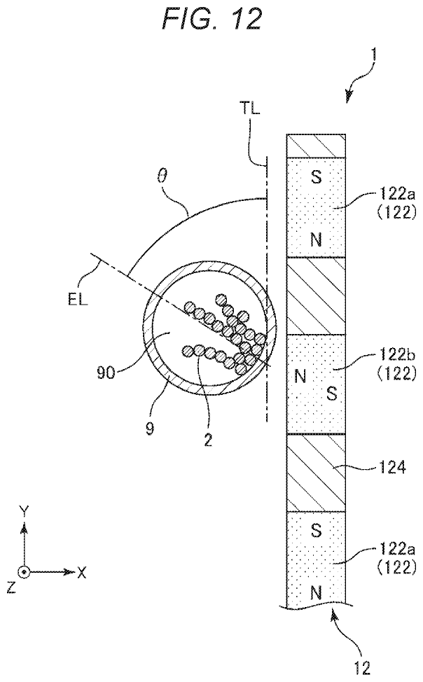

FIG. 12 is a cross-sectional view illustrating an arrangement of the magnets 122 with respect to the container 9.

In the wash solution drying treatment, the magnet 122 may be disposed such that the extension line EL overlaps the container 9, and the magnets 122 are preferably disposed such that an angle θ formed by the extension line EL and a tangent line TL of the inner wall of the container 9 is 45° or more and 90° or less. According to such a configuration, the magnetic beads 2 can be spread over a wider range of the internal space 90 of the container 9. That is, the surface area of the magnetic bead 2 in which the spike phenomenon has occurred can be further increased. Accordingly, the drying efficiency of the magnetic beads 2 can be particularly increased.

When the angle θ is less than the above lower limit, the spike phenomenon may not sufficiently occur, and the surface area of the magnetic bead 2 may not be sufficiently increased.

The tangent line TL of the inner wall of the container 9 refers to a tangent line of an inner wall at a position closest to the magnetic field application unit 12 in a cross-sectional view perpendicular to an axis of the container 9. For example, in the example illustrated in FIG. 12, a tangent line of an inner wall extending parallel to the movable portion 124 of the magnetic field application unit 12 may be set as the tangent line TL.

The angle θ is the smallest angle among the angles formed between the extension line EL and the tangent line TL.

In the wash solution drying treatment, the magnet 122 is preferably left for a while in a state in which the magnets 122 are disposed such that the extension line EL overlaps the container 9. Specifically, the duration of the wash solution drying treatment is preferably 3 minutes or longer, and more preferably 10 minutes or longer. Accordingly, the wash solution can be sufficiently dried, so that the probability that the component in the wash solution is brought into the subsequent step can be further reduced.

In the wash solution drying treatment, the wash solution may be left as described above and naturally dried, but forced drying involving heating, blowing, or the like may be performed as necessary. When the forced drying is performed, the probability of the wash solution remaining can be further reduced, and the time required for drying can be shortened.

In the wash solution drying treatment, the magnet 122 may be disposed at any position in the height direction (Z-axis direction) of the container 9, and as illustrated in FIG. 10, the magnet 122 is preferably disposed above an intermediate point CP of a height H9 of the container 9 (at a position close to an opening 91 of the container 9). That is, a center of the magnet 122 in the Z-axis direction may be located above the intermediate point CP. By disposing the magnet 122 at such a position, the distance between the immobilized magnetic bead 2 and the opening 91 of the container 9 is shortened, and the gas exchange efficiency around the magnetic bead 2 can be increased. As a result, the drying efficiency of the magnetic beads 2 can be further increased.

In the washing step S104, the magnetic bead collection treatment, the wash solution discarding treatment, and the wash solution drying treatment are regarded as one set, and two or more sets thereof may be performed. In this case, the components in the wash solution may be different in each set.

The wash solution is not particularly limited as long as the wash solution is a liquid that does not promote elution of the nucleic acid and does not promote binding of the foreign substance to the magnetic bead 2, and examples thereof include organic solvents such as ethanol, isopropyl alcohol, and acetone, aqueous solutions thereof, and low-salt-concentration aqueous solutions, in addition to water.

Various additives may be added to the wash solution. Examples of the additives include buffers such as an acetic acid buffer and a phosphoric acid buffer, salts such as sodium chloride, and surfactants.

### 2.4. Elution Step

In the elution step S106, the nucleic acids captured by the magnetic beads 2 are eluted into the elution solution. The elution is a treatment of collecting the elution solution by bringing the magnetic beads 2, to which the nucleic acid is adsorbed, into contact with the elution solution in the container 9 to transfer the nucleic acids to the elution solution and then separating the magnetic beads 2 from the elution solution again. In this case, the liquid 3 in FIGS. 7 to 9 is an elution solution.

Specifically, first, the magnetic beads 2 and the elution solution in the container 9 are mixed. Accordingly, the elution solution comes into contact with the magnetic beads 2, and the nucleic acids are eluted into the elution solution. At this time, the elution is preferably performed in a state in which the magnetic field is not applied. Accordingly, the magnetic beads 2 are re-dispersed in the elution solution, and therefore, the elution efficiency can be increased.

Subsequently, a magnetic field is applied to the mixed liquid containing the magnetic beads 2, and the mixed liquid is magnetically attracted to the inner wall of the container 9. Accordingly, as illustrated in FIG. 8, the magnetic beads 2 are moved to the inner wall of the container 9 and immobilized. As a result, the magnetic beads 2 as a solid phase and the elution solution (liquid 3) as a liquid phase can be separated.

Next, the elution solution in the container 9 is collected in a state in which the magnetic beads 2 are immobilized. Specifically, as illustrated in FIG. 9, the elution solution (liquid 3) accumulated at the bottom of the container 9 is sucked and collected by the pipette 6.

The elution solution is not particularly limited as long as it is a liquid that promotes elution of the nucleic acid captured by the magnetic beads 2, and examples thereof include water such as sterile water and pure water.

### 3. Magnetic Bead

Next, an example of the magnetic bead 2 will be described. The configuration of the magnetic beads 2 used in the biological material purification method is not limited to the following.

The magnetic bead 2 illustrated in FIG. 11 includes the magnetic metal particle 22 and the coating layer 24. The coating layer 24 preferably covers the entire surface of the magnetic metal particle 22, but may have a discontinuous portion. The coating layer 24 may be provided as necessary, or may be omitted.

### 3.1. Magnetic Metal Particle

The magnetic metal particles 22 are particles containing a magnetic metal. Examples of the constituent material of the magnetic metal particles 22 include an Fe-based alloy, a Co-based alloy, and a Ni-based alloy. In particular, from the viewpoint of obtaining high saturation magnetization, the constituent material of the magnetic metal particles 22 is preferably an Fe-based alloy (alloy containing Fe as a main component).

The Fe-based alloy may be an alloy having a content of Fe of 50% or more in terms of atomic ratio, and the content of Fe is preferably 70% or more.

The Fe-based alloy contains Fe as a main component, and may contain one or two or more selected from the group including Co, Ni, Cr, Nb, Cu, Al, Mn, Mo, Si, Sn, B, C, P, Ti, and Zr, depending on target characteristics.

An example of the Fe-based alloy is an alloy having a content of Si of preferably 1.0 atomic % or more and 30.0 atomic % or less, more preferably 1.5 atomic % or more and 13.0 atomic % or less, and still more preferably 2.0 atomic % or more and 7.0 atomic % or less. Since such an alloy has high permeability, the saturation magnetization tends to increase.

The Fe-based alloy may contain at least one of boron (B) having a content of 5.0 atomic % or more and 16.0 atomic % or less and carbon (C) having a content of 0.5 atomic % or more and 5.0 atomic % or less. These elements are elements that promote amorphization, and contribute to stably forming an amorphous structure or a nanocrystal structure in the magnetic metal particle 22.

The Fe-based alloy may contain Cr (chromium) having a content of 1.0 atomic % or more and 8.0 atomic % or less. Accordingly, corrosion resistance of the magnetic metal particles 22 can be improved.

A content of impurities is preferably 1.0 atomic % or less in total. At this level, the above effect exhibited by the magnetic metal particles 22 is less likely to be impaired even if impurities are contained. The impurity in the present specification is an element that is unintentionally mixed in raw materials of the magnetic metal particles 22 or during the production of the magnetic metal particles 22.

A main metal structure constituting the magnetic metal particle 22 may take various forms such as a crystal structure, an amorphous structure, and a nanocrystal structure. An amorphous structure refers to a non-crystal structure in which no crystal is present, and a nanocrystal structure refers to a structure mainly formed of fine crystals having a crystal grain diameter of 100 nm or less. The amorphous structure and the nanocrystal structure impart a high hardness to the magnetic metal particles 22. When the structure is the amorphous structure or the nanocrystal structure, the coercive force of the magnetic bead 2 has a particularly low value, which contributes to improvement in the redispersibility of the magnetic bead 2. A volume fraction of the magnetic metal particles 22 having an amorphous structure or a nanocrystal structure is preferably 40% or more, and more preferably 60% or more. The volume fraction is determined based on a result of crystal structure analysis using X-ray diffraction.

The metal structure of the magnetic metal particle 22 can also be identified by performing crystal structure analysis using an X-ray diffraction method on the magnetic metal particle 22. Alternatively, the metal structure can be specified by analyzing a structure observation image or a diffraction pattern obtained with a transmission electron microscope (TEM) from a cut-out sample. For example, in the case of the amorphous structure, a diffraction peak derived from a metal crystal of an α-Fe phase or the like is not observed in peak analysis in the X-ray diffraction method. In the case of the amorphous structure, a so-called halo pattern is formed in an electron diffraction pattern using TEM, and formation of a spot due to a crystal is not observed. The nanocrystal structure is formed of a crystal structure having a grain diameter of, for example, 100 nm or less, and can be checked from a TEM observation image.

The magnetic metal contained in the magnetic metal particle 22 is particularly preferably an Fe-based amorphous alloy containing Fe, Cr, Si, and B. The Fe-based amorphous alloy is an Fe-based alloy including an amorphous structure. Such magnetic metal particles 22 have high magnetic permeability and a low coercive force. Therefore, the magnetic beads 2 having good separability in magnetic separation and excellent redispersibility can be obtained by using such magnetic metal particles 22.

### 3.2. Coating Layer

The coating layer 24 covers the magnetic metal particles 22 and contains gold or an inorganic oxide. According to such a configuration, a function of protecting the magnetic metal particles 22 can be imparted to the coating layer 24. Accordingly, elution of metal ions and the like from the magnetic metal particles 22 can be prevented. As a result, the occurrence of insufficient purification or insufficient inspection due to metal ions or the like can be prevented. The coating layer 24 may be provided as necessary, or may be omitted.

Examples of the inorganic oxide include a silicon oxide, a magnesium oxide, a calcium oxide, an aluminum oxide, a titanium oxide, a zirconium oxide, a boron oxide, an yttrium oxide, and a molybdenum oxide, and a mixture of one or two or more thereof may be used.

The inorganic oxide is preferably silicon oxide. Since the silicon oxide is chemically stable, oxidation and corrosion of the magnetic metal particles 22 can be particularly prevented, and the corrosion resistance of the magnetic beads 2 can be particularly improved. Good nucleic acid adsorptivity can be imparted to the coating layer 24.

The silicon oxide is represented by a composition formula of SiOₓ (0<x≤2), and is preferably SiO₂. The silicon oxide may form a composite oxide or a composite with one or two or more selected from the group including Al, Ti, V, Nb, Cr, Mn, Sn, and Zr.

The coating layer 24 may contain a substance (impurity) other than the inorganic oxide within a range in which an effect thereof is not impaired, for example, at a ratio of 50 mass % or less of the inorganic oxide described above. When the silicon oxide is used as the inorganic oxide, examples of the impurity include C, N, and P.

A composition of the inorganic oxide can be checked by, for example, EDX analysis or Auger electron spectroscopy.

The thickness of the coating layer 24 is preferably 10 nm or more and 200 nm or less, more preferably 15 nm or more and 100 nm or less, and still more preferably 20 nm or more and 100 nm or less. Accordingly, even when the magnetic beads 2 collide with each other or collide with an inner wall of the container 9 or the like, the coating layer 24 can be prevented from being broken or peeled off. As a result, elution of iron ions and the like due to exposure of the magnetic metal particles 22 can be prevented. A decrease in the magnetization per unit volume of the magnetic bead 2 can be prevented, and a decrease in the movement speed of the magnetic beads 2 can be prevented.

Since the gold has high corrosion resistance, a function of reducing oxidation and corrosion of the magnetic metal particles 22 is high. A decrease in the magnetization of the magnetic metal particles 22 can be prevented, and a decrease in the nucleic acid adsorption efficiency due to elution of iron ions or the like can be prevented by providing the coating layer 24 containing gold.

Gold may be present in a state of a simple substance, an alloy, or the like. When the coating layer 24 contains gold, the coating layer 24 may contain impurities other than gold.

The thickness of the gold-containing coating layer 24 is preferably 0.5 nm or more and 50 nm or less, more preferably 1 nm or more and 30 nm or less, and still more preferably 2 nm or more and 20 nm or less. Accordingly, the corrosion resistance of the magnetic beads 2 can be particularly favorably ensured. A decrease in the magnetization per unit volume of the magnetic bead 2 can be prevented, and a decrease in the movement speed of the magnetic beads 2 can be prevented.

The coating layer 24 may cover a surface of one magnetic metal particle 22, or may cover a plurality of magnetic metal particles 22 together.

The thickness of the coating layer 24 can be measured from, for example, a cross-sectional observation image of the magnetic bead 2 observed with a transmission electron microscope or a scanning electron microscope. Specifically, the thickness of the coating layer 24 can be calculated by acquiring a plurality of cross-sectional observation images of the coating layer 24 and averaging measured values from image processing or the like. For example, the thickness of the coating layer 24 is measured at five or more positions for one magnetic bead 2, an average value is determined, and then the average value is further averaged for ten or more magnetic beads 2.

### 3.3. Characteristics of Magnetic Bead

An average particle diameter D50 of the magnetic beads 2 is preferably 0.5 μm or more and 30 μm or less, more preferably 1 μm or more and 20 μm or less, still more preferably 2 μm or more and 15 μm or less, and particularly preferably 3 μm or more and 10 μm or less. When the average particle diameter D50 of the magnetic beads 2 is within the above-described range, a specific surface area of the magnetic beads 2 can be sufficiently large, and an attractive force and an adsorption force suitable for magnetic separation can be generated in the magnetic beads 2. In addition, aggregation of the magnetic beads 2 can be prevented, and dispersibility can be improved.

When the average particle diameter D50 of the magnetic beads 2 is less than the above-described lower limit, the value of the magnetization of the magnetic beads 2 is reduced, and the magnetic beads 2 are likely to aggregate. As a result, there is a concern that the adsorption efficiency of the nucleic acid is reduced, or the foreign substances are likely to be mixed. In addition, the movement speed of the magnetic bead 2 may decrease, and the time required for magnetic separation may increase. On the other hand, when the average particle diameter D50 of the magnetic beads 2 exceeds the upper limit, the specific surface area of the magnetic beads 2 is reduced, and therefore, a sufficient amount of the nucleic acid cannot be adsorbed, and a yield of the nucleic acid may decrease. In addition, the magnetic bead 2 is likely to settle, the magnetic bead 2 that can contribute to the extraction of the nucleic acid may decrease, and the yield of the nucleic acid may decrease.

### The Average Particle Diameter D50 of the

magnetic beads 2 can be determined from a cumulative distribution curve obtained from a volume-based particle size distribution measured by a laser diffraction and dispersion method. Specifically, in the cumulative distribution curve, a particle diameter (median diameter) where a cumulative value is 50% from a small diameter side is the average particle diameter D50 of the magnetic beads 2. Examples of a device that measures the particle size distribution by using the laser diffraction/scattering method include MT3300 series manufactured by MicrotracBEL Corp.

A coercive force Hc of the magnetic metal particle 22 is preferably 100 A/m or less, more preferably 80 A/m or less, still more preferably 60 A/m or less, and particularly preferably 50 A/m or less. The coercive force Hc refers to a value of an external magnetic field in an opposite orientation required to return a magnetized magnetic material to an unmagnetized state. That is, the coercive force Hc means a resistance force against an external magnetic field. As the coercive force Hc of the magnetic metal particle 22 decreases, the magnetic beads 2 are less likely to aggregate when being switched from a state in which a magnetic field is applied to a state in which no magnetic field is applied, and the magnetic beads 2 can be uniformly dispersed in the liquid 3. Further, even when the switching of the magnetic field application is repeated, the redispersibility of the magnetic beads 2 can be improved. A lower limit of the coercive force Hc of the magnetic metal particle 22 is not particularly limited, and is preferably 5 A/m or more from the viewpoint of ease of selection of a material suitable for a balance between performance and cost.

The coercive force Hc of the magnetic metal particle 22 can be measured by a vibrating sample magnetometer or the like in the same manner as the saturation magnetization described above. A maximum applied magnetic field when measuring the coercive force Hc is, for example, 15 kOe.

### 3.4. Method for Producing Magnetic Bead

Next, an example of a method of producing the magnetic beads 2 will be described.

First, the magnetic metal particles 22 are prepared. The magnetic metal particles 22 are produced using a method according to a general metal powder production method. Examples of the production method include a melting process in which a metal is melted, solidified, and powdered, a chemical process in which a powder is produced by a reduction method or a carbonyl method, and a mechanical process in which a metal having a larger shape such as an ingot is mechanically pulverized to obtain a powder. Among them, a melting process such as an atomization method is suitable for producing the magnetic metal particles 22.

Next, the coating layer 24 is formed on the surface of the magnetic metal particle 22. Examples of the method of forming the coating layer 24 include wet formation methods such as a sol-gel method and a plating method, and dry formation methods such as a vacuum deposition method, a sputtering method, and an atomic layer deposition (ALD) method. Among them, a Stober method which is a type of sol-gel method or an ALD method is preferably used.

As described above, the magnetic bead 2 including the magnetic metal particle 22 and the coating layer 24 is obtained.

### 4. Modified Example

Next, a magnetic stand according to a modified example of the embodiment will be described.

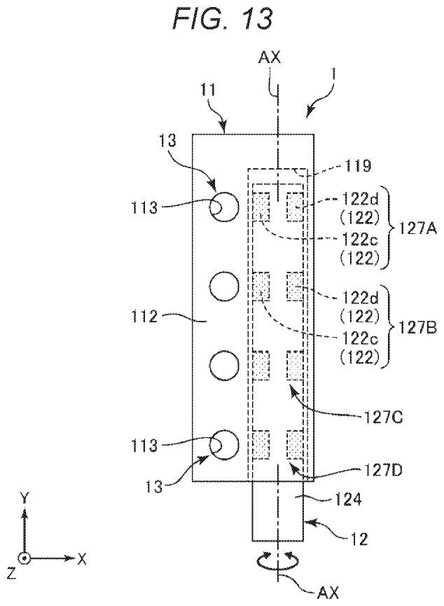

FIG. 13 is a plan view of the magnetic stand 1 according to a modified example of the embodiment.

The modified example will hereinafter be described, but in the following description, differences from the embodiment described above will mainly be described, and description of the same matters will be omitted. Note that in FIG. 13, substantially the same configurations as those in the embodiment described above are provided with the same reference symbols.

The modified example is the same as the embodiment described above except that the configuration of the magnetic field application unit 12 is different.

The magnetic field application unit 12 illustrated in FIG. 13 includes magnet pairs 127A (first magnet pair), 127B (second magnet pair), 127C, and 127D as the magnets 122. The movable portion 124 illustrated in FIG. 13 has a rod shape extending along the Y axis (second axis) and supports the magnet pairs 127A, 127B, 127C, and 127D arranged along the Y axis. Each of the magnet pairs 127A, 127B, 127C, and 127D includes a magnet 122c (third magnet) and a magnet 122d (fourth magnet).

In the magnet 122c, similarly to the first magnet 122a in the embodiment described above, the extension line EL of the orientation of the magnetic pole MP does not overlap the container 9.

On the other hand, in the magnet 122d, similarly to the second magnet 122b in the embodiment described above, the extension line EL of the orientation of the magnetic pole MP overlaps the container 9.

The movable portion 124 illustrated in FIG. 13 is rotatable around the Y axis. When the movable portion 124 rotates, the positions of the plurality of magnets 122 (magnets 122c and 122d) are changed, and the orientation of the magnetic field generated by the magnet 122 is changed.

According to such a magnetic stand 1, the orientation of the magnetic field can be changed as in the embodiment described above, and therefore, the immobilized state of the magnetic beads 2 accommodated in the container 9 can be changed. Accordingly, in the biological material purification method, the wash solution after the magnetic beads 2 are washed can be efficiently removed. As a result, the occurrence of defects due to the wash solution being brought into a subsequent step can be prevented.

Next, the operation of the magnetic stand 1 illustrated in FIG. 13 will be described.

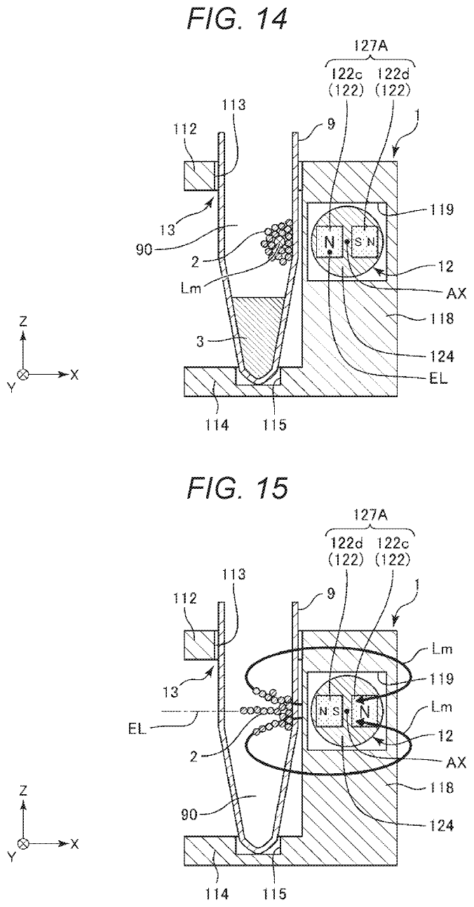

FIGS. 14 and 15 are cross-sectional views of the magnetic stand 1 and the container 9 set in the magnetic stand 1 illustrated in FIG. 13, respectively.

In the magnetic bead collection treatment in the washing step S104, the container 9 is set on the magnetic stand 1 after the magnetic beads 2 to which the nucleic acids are adsorbed are washed with a wash solution. Then, the magnet 122c illustrated in FIG. 14 is disposed close to the container 9. The magnet 122c is similar to the first magnet 122a of the embodiment described above, and as illustrated in FIG. 14, the extension line EL of the orientation of the magnetic pole MP extends in the Y-axis direction and does not overlap the container 9. Therefore, as illustrated in FIG. 14, the magnetic beads 2 can be immobilized to the inner wall of the container 9 in a compact state.

In the wash solution discarding treatment, the wash solution (liquid 3) accumulated at the bottom of the container 9 is discarded by the pipette 6 as illustrated in FIG. 9 in a state in which the magnetic beads 2 are immobilized. Accordingly, the washed magnetic beads 2 remain in the container 9.

In the wash solution drying treatment, the magnetic field application unit 12 of the magnetic stand 1 illustrated in FIG. 13 is operated to change a relative posture of the magnetic field application unit 12 relative to the base 11 from a posture illustrated in FIG. 14 to a posture illustrated in FIG. 15. The magnet 122d illustrated in FIG. 15 is disposed close to the container 9. The magnet 122d is similar to the second magnet 122b in the embodiment described above, and as illustrated in FIG. 15, the extension line EL of the orientation of the magnetic pole MP extends in the X-axis direction and overlaps the container 9. Therefore, a phenomenon (spike phenomenon) in which the magnetic beads 2 are arranged in a needle shape as illustrated in FIG. 15 occurs in the magnetic beads 2. Accordingly, the wash solution adhering to the magnetic beads 2 can be efficiently dried. As a result, the wash solution can be efficiently removed, and the components in the wash solution can be prevented from being brought into the subsequent step.

In the magnetic stand 1 illustrated in FIG. 13, a state in which the magnets 122c are disposed close to the container 9 and a state in which the magnets 122d are disposed close to the container 9 can be easily switched only by rotating the movable portion 124 around a rotation axis AX. Specifically, when a rotation angle of the movable portion 124 is a first rotation angle, the magnet 122c (third magnet) is close to the container 9 as illustrated in FIG. 14. On the other hand, when the rotation angle of the movable portion 124 is a second rotation angle obtained by rotating the movable portion 124 by 180° from the first rotation angle, the magnet 122d (fourth magnet) is close to the container 9 as illustrated in FIG. 15. According to such a configuration, the magnetic flux density formed in the container 9 can be easily changed, and the immobilized state of the magnetic beads 2 can be easily changed.

In such a modified example as described above, substantially the same advantages as those of the embodiment described above can be obtained.

### 5. Biological Material Purification Device

A biological material purification device according to an embodiment will be described.

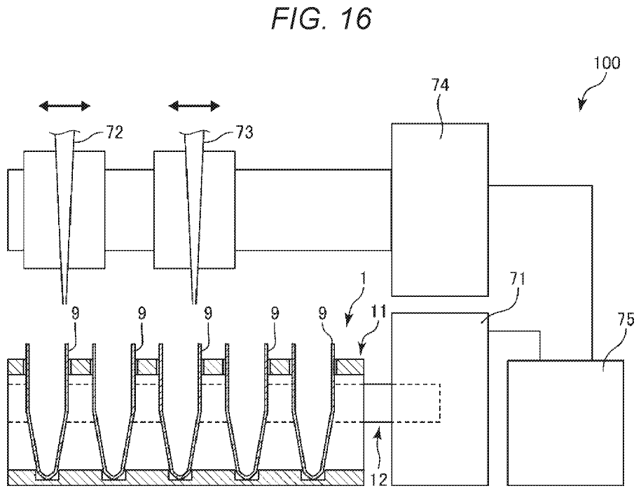

FIG. 16 is a schematic diagram illustrating a schematic configuration of a biological material purification device 100 according to the embodiment.

Hereinafter, the biological material purification device 100 according to the embodiment will be described, but in the following description, differences from the biological material purification method according to the embodiment described above will be mainly described, and description of the same configuration will be omitted. Note that in FIG. 16, substantially the same configurations as those in the embodiment described above are provided with the same reference symbols.

The biological material purification device 100 illustrated in FIG. 16 includes the magnetic stand 1, a stand drive unit 71, a wash solution supply unit 72, a wash solution discarding unit 73, a supply/discarding drive unit 74, and a control unit 75.

The stand drive unit 71 translates or rotates the magnetic field application unit 12 of the magnetic stand 1. Accordingly, the orientation of the magnetic field applied to the container 9 set in the magnetic stand 1 is changed.

The wash solution supply unit 72 supplies the wash solution to the container 9 set in the magnetic stand 1. The wash solution discarding unit 73 discards the wash solution from the container 9 set in the magnetic stand 1. Examples of the wash solution supply unit 72 and the wash solution discarding unit 73 include an electric pipettor.

The supply/discarding drive unit 74 changes relative positions of the wash solution supply unit 72 and the wash solution discarding unit 73 relative to the magnetic stand 1. Accordingly, the wash solution can be supplied to a predetermined container 9 from among the plurality of containers 9, or the wash solution can be discarded from a predetermined container 9.

The control unit 75 controls operations of the stand drive unit 71, the wash solution supply unit 72, the wash solution discarding unit 73, and the supply/discard drive unit 74. Accordingly, the biological material purification method according to the embodiment described above can be automatically performed.

Specifically, in the washing step S104, first, the wash solution supply unit 72 supplies a wash solution to the container 9 to perform washing. Next, the magnetic bead collection treatment is performed. Specifically, the stand drive unit 71 drives the magnetic field application unit 12 of the magnetic stand 1 to dispose the first magnet 122a close to the container 9. Next, the wash solution discarding treatment is performed. Specifically, the wash solution discarding unit 73 discards the wash solution from the container 9. At this time, the immobilized state of the magnetic beads 2 is optimized, and therefore, interference between the immobilized magnetic beads 2 and the wash solution discarding unit 73 can be prevented. Accordingly, the reliability of the wash solution discarding treatment can be increased, and the wash solution can be efficiently removed. Next, the wash solution drying treatment is performed. Specifically, the stand drive unit 71 drives the magnetic field application unit 12 to dispose the second magnet 122b close to the container 9. This state is maintained for a certain period of time. At this time, the immobilized state of the magnetic beads 2 is optimized, and therefore, the wash solution can be sufficiently dried. Accordingly, the occurrence of defects due to the wash solution being brought into the subsequent step can be prevented.

The biological material purification device 100 may include a heating mechanism and an air blowing mechanism in addition to the above configuration. The heating mechanism heats the wash solution and the magnetic beads 2 to promote drying of the wash solution. The blowing mechanism increases gas exchange efficiency around the magnetic beads 2 and promotes drying of the wash solution.

### 6. Effects of Embodiment

As described above, the biological material purification method according to the embodiment includes the adsorption step S102, the washing step S104, and the elution step S106. In the adsorption step S102, the magnetic beads 2 having a saturation magnetization of 50 emu/g or more, the biological material, and the liquid 3 are charged in the container 9, the biological material is adsorbed to the magnetic beads 2, and then the liquid 3 is removed. In the washing step S104, the magnetic beads 2 to which the biological material is adsorbed are washed with a wash solution after the adsorption step S102. In the elution step S106, the biological material adsorbed to the magnetic beads 2 is eluted after the washing step S104.

The washing step S104 includes a magnetic bead collection treatment, a wash solution discarding treatment, and a wash solution drying treatment. In the magnetic bead collection treatment, the magnetic bead 2 to which the biological material is adsorbed is washed with a wash solution, and then the magnet 122 is disposed such that the extension line EL of the orientation of the magnetic pole MP does not overlap the container 9, thereby fixing the magnetic beads 2. In the wash solution discarding treatment, the wash solution in the container 9 is discarded in a state in which the magnetic beads 2 are immobilized. In the wash solution drying treatment, after the wash solution discarding treatment, the wash solution is dried in a state in which the magnet 122 is disposed such that the extension line EL of the orientation of the magnetic pole MP overlaps the container 9, and the magnetic field gradient in the container 9 is 40 T/m or more.

According to such a configuration, the immobilized state of the magnetic beads 2 can be optimized in the wash solution drying treatment, and therefore, the wash solution can be sufficiently dried. Accordingly, the occurrence of defects due to the wash solution being brought into the subsequent step can be prevented. According to the configuration described above, the immobilized state of the magnetic beads 2 can be optimized in the wash solution discarding treatment, and therefore, the interference between the immobilized magnetic beads 2 and the pipette 6 can be prevented. Accordingly, the workability of the wash solution discarding treatment can be improved, and the wash solution can be efficiently removed.

In the biological material purification method according to the embodiment, the saturation magnetization of the magnetic beads 2 is preferably 100 emu/g or more, and the magnetic field gradient in the container 9 in the wash solution drying treatment is preferably 100 T/m or more.

According to such a configuration, the drying efficiency of the magnetic beads 2 can be particularly enhanced. A movement speed of the magnetic bead 2 in a magnetic field can be increased, and therefore, a time required for magnetic separation can be shortened.

In the biological material purification method according to the embodiment, the wash solution drying treatment is preferably performed in a state in which the magnet 122 is disposed such that the angle θ formed by the extension line EL of the orientation of the magnetic pole MP and the tangent line TL of the inner wall of the container 9 is 45° or more and 90° or less.

According to such a configuration, the magnetic beads 2 can be spread over a wider range of the internal space 90 of the container 9. Accordingly, the drying efficiency of the magnetic beads 2 can be particularly increased.

In the biological material purification method according to the embodiment, the duration of the wash solution drying treatment is preferably 3 minutes or longer.

According to such a configuration, the wash solution can be sufficiently dried, and therefore, the probability that the component in the wash solution is brought into the subsequent step can be further reduced.

In the biological material purification method according to the embodiment, a position of the magnet 122 in the wash solution drying treatment is preferably a position closer to the opening than the intermediate point CP of the height H9 of the container 9.

According to such a configuration, a distance between the fixed magnetic beads 2 and the opening 91 of the container 9 is shortened, and the gas exchange efficiency around the magnetic beads 2 can be increased. As a result, the drying efficiency of the magnetic beads 2 can be further increased.

The magnetic stand 1 according to the embodiment is a magnetic stand that separates the magnetic beads 2 and the liquid 3 by applying a magnetic field by the magnet 122 to the container 9 accommodating the magnetic beads 2, the biological material, and the liquid 3, and includes the base 11 and the magnetic field application unit 12. The base 11 extends along the Z axis (first axis) and has the insertion hole 13 into which the container 9 is to be inserted. The magnetic field application unit 12 is provided in the base 11 and applies a magnetic field to the insertion hole 13.

The magnetic field application unit 12 includes a plurality of magnets 122 and the movable portion 124 that changes positions of the magnets 122. Further, the movable portion 124 has a rod shape extending along the Y axis (second axis) intersecting the Z axis (first axis), supports the plurality of magnets 122 arranged along the Y axis, and changes the orientation of the magnetic field generated by the plurality of magnets 122 by translating along the Y axis or rotating around the Y axis.

According to such a configuration, the orientation of the magnetic field can be changed, and therefore, the immobilized state of the magnetic beads 2 accommodated in the container 9 can be changed. Accordingly, in the biological material purification method, the wash solution after the magnetic beads 2 are washed can be efficiently removed. As a result, the occurrence of defects due to the wash solution being brought into a subsequent step can be prevented.

In the magnetic stand 1 according to the embodiment, the magnetic field application unit 12 may include the first magnet 122a and the second magnet 122b as the magnets 122. In this case, the movable portion 124 translates along the Y axis (second axis). The first magnet 122a is supported by the movable portion 124 such that an extension line EL of an orientation of a magnetic pole MP does not overlap the container 9. The second magnet 122b is provided at a position adjacent to the first magnet 122a along the Y axis, and is supported by the movable portion 124 such that an extension line EL of an orientation of a magnetic pole MP overlaps the container 9.

According to such a configuration, it is possible to obtain the magnetic stand 1 capable of easily changing the orientation of the magnetic field applied to the container 9 by translating the magnetic field application unit 12 in the Y-axis direction. Therefore, it is possible to implement the magnetic stand 1 capable of easily changing the magnetic flux density formed in the container 9 and easily changing the immobilized state of the magnetic beads 2.

In the magnetic stand 1 according to the embodiment, the magnetic field application unit 12 may include the magnet pair 127A (first magnet pair) and the magnet pair 127B (second magnet pair) as the magnets 122. In this case, the movable portion 124 rotates around the Y axis (second axis) between the first rotation angle and the second rotation angle obtained by rotating the movable portion 124 by 180° from the first rotation angle. Each of the first magnet pair 127A and the second magnet pair 127B includes the magnet 122c (third magnet) disposed such that an extension line EL of an orientation of a magnetic pole MP does not overlap the container 9 when the movable portion 124 is in a posture of the first rotation angle, and a fourth magnet disposed such that an extension line EL of an orientation of a magnetic pole MP overlaps the container 9 when the movable portion 124 is in a posture of the second rotation angle.

According to such a configuration, it is possible to obtain the magnetic stand 1 capable of easily changing the orientation of the magnetic field applied to the container 9 by rotating the magnetic field application unit 12 around the Y axis. Therefore, it is possible to implement the magnetic stand 1 capable of easily changing the magnetic flux density formed in the container 9 and easily changing the immobilized state of the magnetic beads 2.

The biological material purification device 100 according to the embodiment includes the magnetic stand 1 according to the embodiment, the stand drive unit 71, the wash solution supply unit 72, the wash solution discarding unit 73, and the control unit 75. The stand drive unit 71 drives the magnetic field application unit 12 of the magnetic stand 1. The wash solution supply unit 72 supplies the wash solution to the container 9 inserted into the insertion hole 13 of the magnetic stand 1. The wash solution discarding unit 73 discards the wash solution from the container 9. The control unit 75 controls the operation of the stand drive unit 71, the operation of the wash solution supply unit 72, and the operation of the wash solution discarding unit 73.

According to such a configuration, the biological material purification method including the magnetic bead collection treatment, the wash solution discarding treatment, and the wash solution drying treatment can be automatically performed. The immobilized state of the magnetic beads 2 can be optimized in the wash solution drying treatment, and therefore, the wash solution can be sufficiently dried. Accordingly, the occurrence of defects due to the wash solution being brought into the subsequent step can be prevented. The immobilized state of the magnetic beads 2 can be optimized in the wash solution discarding treatment, and therefore, interference between the immobilized magnetic beads 2 and the wash solution discarding unit 73 can be prevented. Accordingly, the reliability of the wash solution discarding treatment can be increased, and the wash solution can be efficiently removed.

In the biological material purification device 100 according to the embodiment, the control unit 75 may operate the stand drive unit 71 to dispose the magnet 122 such that the extension line EL of the orientation of the magnetic pole MP does not overlap the container 9, operate the wash solution discarding unit 73 to discard the wash solution from the container 9, and then operate the stand drive unit 71 to hold the magnet 122 in a state in which the magnet 122 is disposed such that the extension line EL of the orientation of the magnetic pole MP overlaps the container 9.

According to such a configuration, the immobilized state of the magnetic beads 2 can be optimized in the wash solution drying treatment, and therefore, the wash solution can be sufficiently dried. The immobilized state of the magnetic beads 2 can be optimized in the wash solution discarding treatment, and therefore, interference between the immobilized magnetic beads 2 and the wash solution discarding unit 73 can be prevented.

Although the biological material purification method, the magnetic stand, and the biological material purification device according to the present disclosure have been described above based on the illustrated embodiments, the present disclosure is not limited thereto. For example, the biological material purification method according to the present disclosure may be a method in which a step for any purpose is added to the embodiment. In the magnetic stand and the biological material purification device according to the present disclosure, any configuration may be added to the embodiment, or a part of the configuration of the embodiment may be replaced with another configuration having the same function.

### EXAMPLES

Next, specific examples of the present disclosure will be described.

### 7. Production of Magnetic Beads and Nucleic Acid Purification

Magnetic beads of each example and each comparative example were produced as follows, and then, nucleic acid purification was performed using the produced magnetic beads.

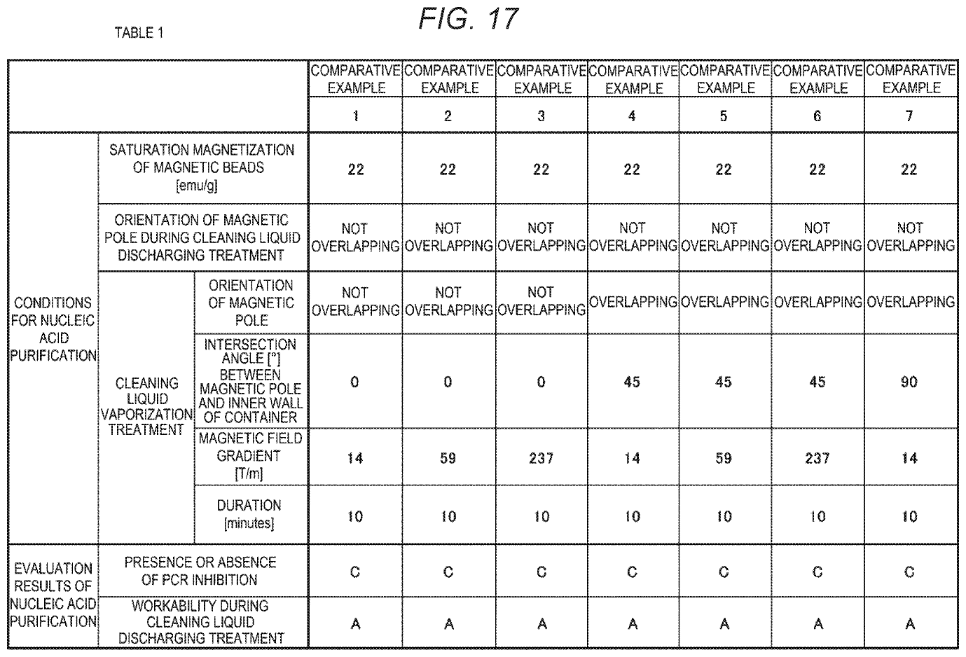

FIG. 17 is Table 1 illustrating conditions of a washing step in nucleic acid purification using magnetic beads in Comparative Examples and evaluation results of the nucleic acid purification.

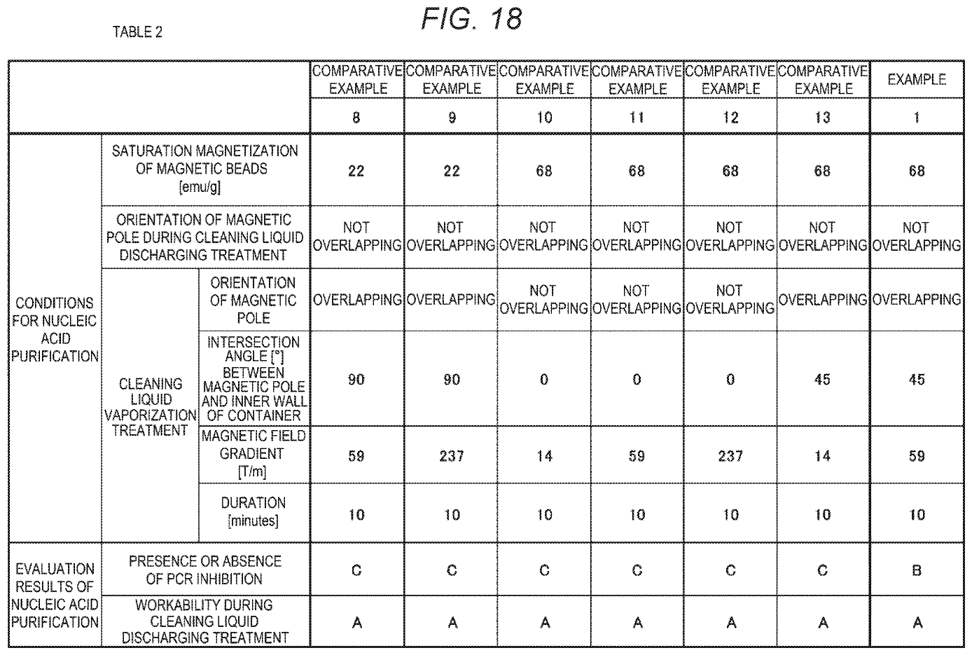

FIG. 18 is Table 2 illustrating conditions of washing steps in nucleic acid purification using magnetic beads of Examples and Comparative Examples and evaluation results of the nucleic acid purification.

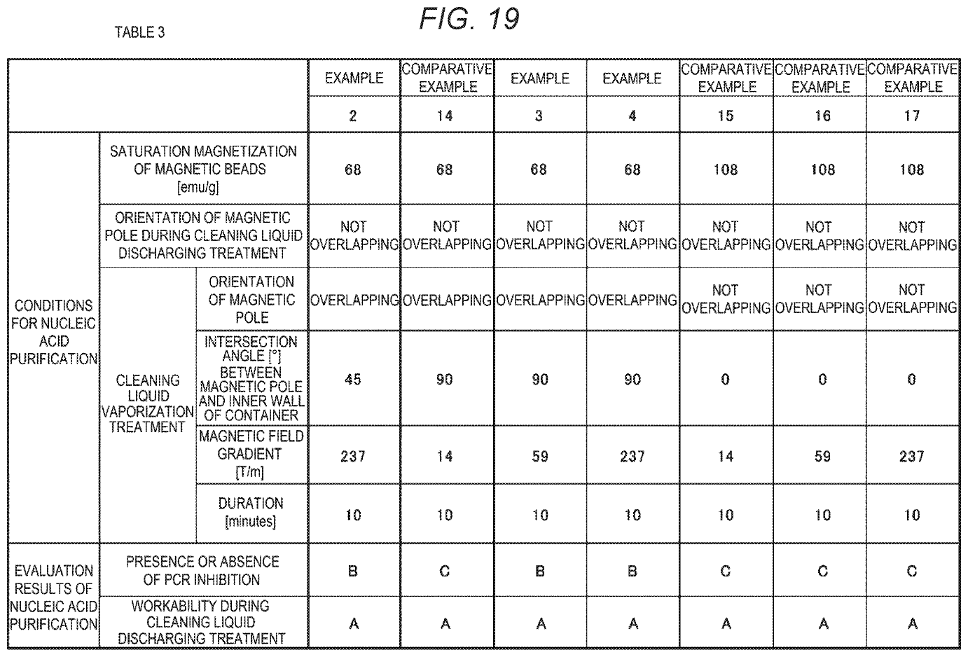

FIG. 19 is Table 3 illustrating conditions of the washing step in the nucleic acid purification using magnetic beads of Examples and Comparative Examples and evaluation results of the nucleic acid purification.

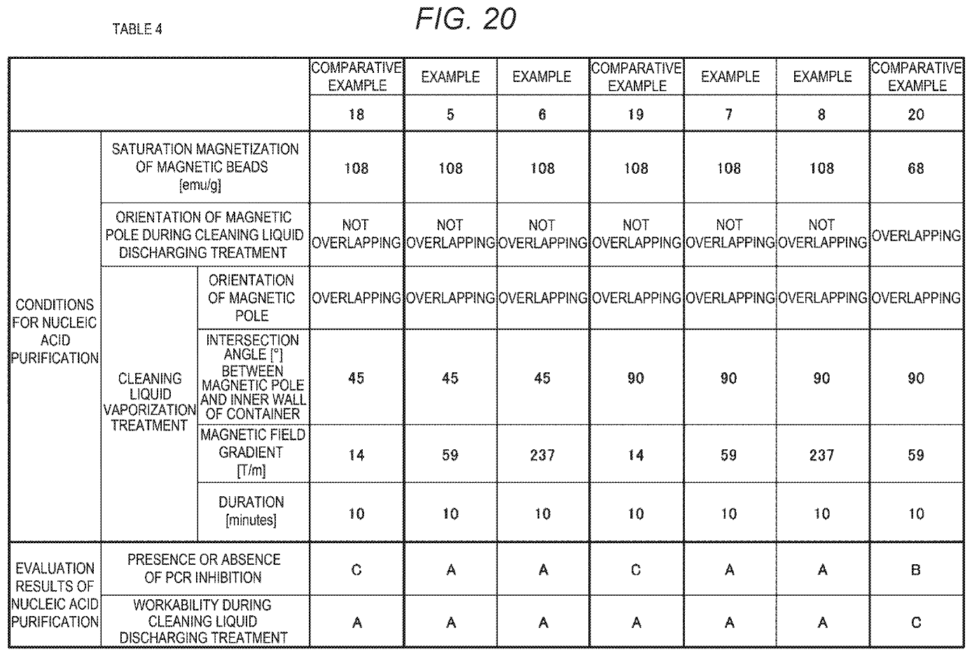

FIG. 20 is Table 4 illustrating conditions of washing steps in nucleic acid purification using magnetic beads of Examples and Comparative Examples and evaluation results of the nucleic acid purification.

### 7.1. Example 1

First, the production of magnetic beads and nucleic acid purification of Example 1 will be described.

### 7.1.1. Production of Magnetic Bead

First, an Fe-based amorphous alloy powder produced by a water atomization method was prepared as magnetic metal particles.

Next, TEOS (tetraethoxysilane) was brought into contact with surfaces of the magnetic metal particles by a Stober method, and then firing was performed to form a coating layer formed of silicon oxide. Accordingly, magnetic beads were obtained. The saturation magnetization of the produced magnetic beads is illustrated in Table 2 (FIG. 18).

Other characteristics of the produced magnetic beads are as follows.
Average particle diameter D50:10 μm
Coercive force: 50 A/m
Thickness of coating layer: 30 nm

### 7.1.2. Nucleic Acid Purification

First, the magnetic bead dispersion liquid containing 20 mg of the magnetic beads of Example 1 was taken into a 1.5 mL tube and left to stand until room temperature was reached.

Next, another 1.5 mL tube (container) was prepared, and a sample liquid containing the nucleic acid was taken out and left to stand until the room temperature was reached.

Next, an adsorption step was performed. Specifically, 750 μL of the magnetic bead dispersion liquid and the lysis-adsorption liquid were added to a tube into which the sample liquid was charged. Then, the substances accommodated in the tube were mixed for 9 minutes with a vortex mixer. Subsequently, the tube after mixing was set in the magnetic stand illustrated in FIG. 1, and the magnetic separation treatment and the liquid discarding treatment were performed.

Next, a washing step was performed. Specifically, 500 μL of a wash solution was added to the tube after the adsorption step. An aqueous ethanol solution having a volume concentration of 80% was used as the wash solution. Then, the substances accommodated in the tube were mixed for 3 minutes with a vortex mixer. Thereafter, a magnetic bead collection treatment was performed. In the magnetic bead collection treatment, the tube was set on a magnetic stand and left for 20 seconds to immobilize the magnetic beads to the inner wall of the tube. At this time, the orientation of the magnetic pole was set to the orientation illustrated in Table 2. Subsequently, a wash solution discarding treatment was performed. In the wash solution discarding treatment, the wash solution in the supernatant was removed using a pipette. Subsequently, a wash solution drying treatment was performed. In the wash solution drying treatment, the tube was set on a magnetic stand and left for the duration illustrated in Table 2. Accordingly, the wash solution adhering to the magnetic beads was dried. At this time, the magnetic field application unit of the magnetic stand was operated to set the orientation of the magnetic pole and an intersection angle between the magnetic pole and the inner wall of the container as illustrated in Table 2. The surface magnetic flux density of the magnet and the distance between the magnet and the container were set such that the magnetic field gradient in the tube reached the values illustrated in Table 2.

Next, the elution step was performed. Specifically, 50μL of an elution solution adjusted to room temperature was added to the tube after the washing step. Ultrapure water was used as the elution solution. Then, the substances accommodated in the tube were mixed for 3 minutes with a vortex mixer. Accordingly, the nucleic acid captured by the magnetic beads was eluted. Thereafter, a magnetic separation treatment was performed. In the magnetic separation treatment, the tube was set on a magnetic stand and left for 30 seconds. Subsequently, a liquid discarding treatment was performed, and the elution solution in the supernatant was collected.

### 7.2. Examples 2 to 8 and Comparative Examples 1 to 20

Magnetic beads were produced, and nucleic acid purification was performed in the same manner as in Example 1 except that the configuration of the magnetic beads and the conditions for the nucleic acid purification were changed as illustrated in Table 1 (FIG. 17), Table 2 (FIG. 18), Table 3 (FIG. 19), and Table 4 (FIG. 20).

### 8. Evaluation of Nucleic Acid Purification

Next, the nucleic acid purification of each of Examples and Comparative Examples was evaluated.

### 8.1. Presence or Absence of PCR Inhibition

The presence or absence of PCR inhibition in nucleic acid purification was evaluated as follows.

First, 2 μL of the collected elution solution was supplied to a 10 μL real-time PCR reaction system to determine the number of cycles until the PCR amplification curve crosses the threshold (yielding a Ct value). When the wash solution or the like is absorbed into the magnetic beads and becomes a residual liquid, the residual liquid may transfer to the elution solution and cause PCR inhibition. At this time, the number of cycles increases. Therefore, PCR inhibition due to transfer of the wash solution was evaluated by observing, according to the following evaluation criteria, the number of cycles until the PCR amplification curve crosses the threshold (yielding a Ct value). Evaluation results are illustrated in Tables 1 to 4.
A: the PCR amplification curve crosses the threshold at a sufficient speed
B: the rise of the PCR amplification curve is slower than A, but the test is not hindered
C: PCR amplification curve does not crosse the threshold
   8.2. Workability During Wash solution Discarding Treatment

The workability during the wash solution discarding treatment in the washing step was evaluated as follows.

In the wash solution discarding treatment, the wash solution in the supernatant was removed using a pipette. The workability at this time was evaluated in view of the following evaluation criteria. Evaluation results are illustrated in Tables 1 to 4.
A: the distance between the pipette and the magnetic bead is sufficient, and the workability is very good
B: the distance between the pipette and the magnetic bead is small, and the operation takes a little time
C: the pipette and the magnetic beads interfere with each other, and workability is poor

### 8.3. Consideration

From the evaluation results illustrated in Tables 1 to 4, the following can be recognized.

In the nucleic acid purification of each example, the occurrence of PCR inhibition due to the transfer of the wash solution could be prevented. From this result, it was found that the wash solution drying treatment is effective from the viewpoint of sufficiently and efficiently removing the wash solution and preventing the test failure of the nucleic acid.

In the nucleic acid purification of each comparative example, a sufficient effect was not obtained from the viewpoint of preventing PCR inhibition. Examples of this reason include insufficient saturation magnetization of the magnetic beads, the orientation of the magnetic pole in the wash solution drying treatment, and the magnetic field gradient.

In the nucleic acid purification of each example, it was found that workability during the wash solution discarding treatment in the washing step was high. From this result, it was found that the optimization of the orientation of the magnetic field during the wash solution discarding treatment is effective from the viewpoint of efficiently removing the wash solution.

What is claimed is:

1. A biological material purification method comprising:
an adsorption step of charging magnetic beads having a saturation magnetization of 50 emu/g or more, a biological material, and a liquid into a container, adsorbing the biological material to the magnetic beads, and then removing the liquid;
a washing step of washing, with a wash solution, the magnetic beads to which the biological material is adsorbed after the adsorption step; and
an elution step of eluting the biological material adsorbed to the magnetic beads after the washing step, wherein
the washing step includes
a magnetic bead collection treatment of immobilizing the magnetic beads by washing, with the wash solution, the magnetic beads to which the biological material is adsorbed, and then disposing a magnet such that an extension line of an orientation of a magnetic pole does not overlap the container,
a wash solution discarding treatment of discarding the wash solution in the container in a state in which the magnetic beads are immobilized, and
a wash solution drying treatment of vaporizing, after the wash solution discarding treatment, the wash solution in a state in which the magnet is disposed such that the extension line of the orientation of the magnetic pole overlaps the container and a magnetic field gradient in the container is 40 T/m or more.

2. The biological material purification method according to claim 1, wherein
the saturation magnetization of the magnetic beads is 100 emu/g or more, and
the magnetic field gradient in the container in the wash solution drying treatment is 100 T/m or more.

3. The biological material purification method according to claim 1, wherein
the wash solution drying treatment is performed in a state in which the magnet is disposed such that an angle formed by the extension line of the orientation of the magnetic pole and a tangent line of an inner wall of the container is 45° or more and 90° or less.

4. The biological material purification method according to claim 1, wherein
a duration of the wash solution drying treatment is 3 minutes or longer.

5. The biological material purification method according to claim 1, wherein
a position of the magnet in the wash solution drying treatment is a position closer to an opening than an intermediate point of a height of the container.

6. A magnetic stand for separating, by applying a magnetic field generated by a magnet to a container accommodating magnetic beads, a biological material, and a liquid, the magnetic beads and the liquid, the magnetic stand comprising:
a base extending along a first axis and having an insertion hole into which the container is to be inserted; and
a magnetic field application unit provided on the base and configured to apply the magnetic field to the insertion hole, wherein
the magnetic field application unit includes
a plurality of the magnets, and
a movable portion configured to change positions of the magnets, and
the movable portion has a rod shape extending along a second axis intersecting the first axis, supports the plurality of magnets arranged along the second axis, and changes, by translating along the second axis or rotating around the second axis, an orientation of a magnetic field generated by the plurality of magnets.

7. The magnetic stand according to claim 6, wherein
the magnetic field application unit includes a first magnet and a second magnet as the magnets,
the movable portion translates along the second axis,
the first magnet is supported by the movable portion such that an extension line of an orientation of a magnetic pole does not overlap the container, and
the second magnet is provided at a position adjacent to the first magnet along the second axis, and is supported by the movable portion such that an extension line of an orientation of a magnetic pole overlaps the container.

8. The magnetic stand according to claim 6, wherein
the magnetic field application unit includes a first magnet pair and a second magnet pair as the magnets,
the movable portion rotates around the second axis between a first rotation angle and a second rotation angle obtained by rotating the movable portion by 180°from the first rotation angle, and
each of the first magnet pair and the second magnet pair includes a third magnet disposed such that an extension line of an orientation of a magnetic pole does not overlap the container when the movable portion is in a posture with the first rotation angle, and a fourth magnet disposed such that an extension line of an orientation of a magnetic pole overlaps the container when the movable portion is in a posture with the second rotation angle.

9. A biological material purification device comprising:
the magnetic stand according to claim 6;
a stand drive unit configured to drive the magnetic field application unit of the magnetic stand;
a wash solution supply unit configured to supply a wash solution to the container inserted into the insertion hole of the magnetic stand;
a wash solution discarding unit configured to discard the wash solution from the container; and
a control unit configured to control an operation of the stand drive unit, an operation of the wash solution supply unit, and an operation of the wash solution discarding unit.

10. The biological material purification device according to claim 9, wherein
the control unit operates the stand drive unit to dispose the magnet such that an extension line of an orientation of a magnetic pole does not overlap the container, operates the wash solution discarding unit to discard the wash solution from the container, and then operates the stand drive unit to hold the magnet in a state in which the magnet is disposed such that the extension line of the orientation of the magnetic pole overlaps the container.
